(19) United States
(12) Patent Application Publication
(10) Pub. No.: US 2009/0008615 A1
(43) Pub. Date: Jan. 8, 2009

(54) ROLLER CHAIN AND SPROCKET SYSTEM

(75) Inventors: Darren YOUNG, Red Deer (CA); Jed WOOD, Sylvan Lake (CA)

Correspondence Address: SEAN W. GOODWIN, 222 PARKSIDE PLACE, 602-12 AVENUE S.W., CALGARY, AB, T2R 1J3, CA

(73) Assignee: HIGH ARCTIC ENERGY SERVICES LIMITED PARTNERSHIP, Red Deer (CA)

(21) Appl. No.: 12/135,877

(22) Filed: Jun. 9, 2008

Related U.S. Application Data
(60) Provisional application No. 60/942,618, filed on Jun. 7, 2007.

(51) Int. Cl. B66F 3/00

(52) U.S. Cl. 254/133 R

(57) ABSTRACT

A roller chain and sprocket system utilizes an involute profile on the sprocket teeth to engage rollers in the links of a roller chain. The links, when aligned linearly, bear upon one another when pushed to form a substantially rigid column which has an axis. The system results in substantially 100% of the rotational energy imparted to the sprocket being translated into linear motion of the chain along the column axis.

### CROSS REFERENCE TO RELATED APPLICATION

This application is a regular application claiming priority of U.S. Provisional Patent application Ser. No. 60/942,618, filed on Jun. 7, 2007, the entirety of which is incorporated herein by reference.

### FIELD OF THE INVENTION

Embodiments of the invention relate to chains and sprockets used for translating a load and, more particularly, to a chain and sprocket for lifting and lowering a load vertically in a mast of a drilling rig.

### BACKGROUND OF THE INVENTION

A multitude of different chain and sprocket drives are known in many industries for pushing and pulling a load. Many design considerations must be taken into account depending upon the size of the load to be moved and the direction in which it is to be moved.

Typically, the links of a flexible chain must interlock to achieve vertical translation. One such interlocking hoisting chain design is taught in U.S. Pat. No. 1,427,642 to Rickard. In use, the chain length unravels from around the sprocket during rotation, the chain interlocking as it goes from circular to linear motion. A thrust backer plate is required to ensure engagement between the chain and the sprocket due to side loading on the chain.

U.S. Pat. No. 6,224,037 to Novick teaches an interlocking roller chain driven vertically by two pinions which engage opposing ends of the chain rollers. The pinions are enclosed between two flange plates. Drive rollers on the chain engage the pinions therebetween. Applicant believes Novick's device has a low teeth to pinion diameter ratio and is similarly subject to side loading which diminishes the efficiency of the vertical translation. Further Applicant believes that a thrust backer plate opposes the pinions to assist in maintaining engagement between the pinions and the chain.

In the case of a drilling rig, large loads are lowered by gravity and pulled vertically in and out of a wellbore. Typically, this lifting and lowering is accomplished using a cable and pulley drawworks system for a conventional tubular drilling rig or an injector or chain drive for a coiled tubing drilling rig.

U.S. Pat. No. 6,336,622 to Eilertsen et al. (Engineering & Drilling Machinery AS (EDM), Stavanger, Norway) teaches a linked rack and pinion system for raising and lowering a load bearing yoke in a derrick. Each of the rack links is an H-beam in cross-section having teeth on parallel opposing flanges. The rack links bear against one another in a vertical guideway in the derrick. An idler wheel is positioned at the bottom of the derrick for guiding the rack in a “U-shaped” track to a storage guideway. Load is taken up at the bottom of the derrick. A pinion driving gear powered by a plurality of drive motors engages the rack for pushing and pulling the plurality of interlinked racks.

Applicant believes that the EDM arrangement is prone to high sliding contact stresses between the gear teeth and the rack teeth. A pressure angle is substantially a measure of the driving energy which is lost. A typical industry standard for rack and pinion or sprocket and chain drives is about 20° or 25° for a strong gear. At a pressure angle of 20°, about 77% of the energy is utilized for work and about 22% generates a negative force that acts to constantly drive the teeth of the rack and the pinion gear apart. The lifting force of the EDM system has about a 20° to 25° pressure angle which generates sliding friction and creates a significant negative force, pushing the pinion out of engagement with the rack. Typically pairs of opposing pinions are used in an attempt to balance the disengaging force, reducing the efficiency of the system. Applicant notes that a stress analysis of an exemplary EDM gear at a load of 41,667 lbs results in a stress of about 35,700 psi per rack and pinion.

Conventionally, materials used for gear and pinions are treated to handle friction and stresses imposed thereon. Such treated materials are not suitable for use in cold climates, such as the Arctic and particularly when subjected to the high stresses imposed by use in a drilling rig. Lubrication is typically required for prevention of premature wear of the gear tooth surfaces. Lack of lubrication or use of contaminated oil typically results in excessive wear.

There is great interest in the oil and gas industry to find a drive mechanism which can be efficiently pushed and pulled, which is capable of handling large loads with lower stress and with minimal thrust side loading, particularly for vertical lifting and lowering of the load. Further, there is interest in reducing the weight of the system to assist in meeting transportation weight restrictions in the case of a mobile drilling rig. Of particular interest is the ability to utilize materials that are suitable for cold climates under reduced stress.

Additionally, there is great interest in industries other than oil and gas drilling which require large pushing and pulling forces to handle loads of a variety of types with reduced stress on the lifting components, reduced maintenance and improved efficiency.

### SUMMARY OF THE INVENTION

Embodiments of the invention utilize interconnectable roller chain links for forming an articulated roller chain. Each of the links bears upon an adjacent link, when aligned linearly, for forming a substantially rigid pushing column. The column is engaged at a linear portion thereof by one or more co-operating sprockets having teeth with an involute profile suitable for driving the roller chain along a column axis. A resulting pressure angle is substantially zero and therefore substantially all of the driving force of the sprocket is translated to movement of the roller chain along the column axis substantially without thrust side loading. Embodiments of the invention are suitable to efficiently translate loads and particularly to translate heavy loads vertically.

In a broad aspect of the invention, a system for pushing a load comprises: an articulated roller chain having a plurality of pivotally connected links, each of the plurality of links being caused, when linearly aligned and pushed, to bear upon an adjacent link for forming a substantially rigid linear column portion having a column axis; and one or more sprockets having a plurality of teeth formed thereon, the teeth having an involute profile for engaging the roller chain at the substantially rigid linear column portion thereof, wherein the involute profile of the sprocket teeth engages the roller chain to translate substantially all of a rotational driving energy from the sprocket to the roller chain along a line of action perpendicular to a tangent to the involute curve, the line of action being along the column axis for movement of the roller chain along the column axis.

In another broad aspect of the invention, a rig for raising and lowering a load comprises: a platform; one or more masts supported on the platform; a U-shaped articulated roller chain for raising and lowering the load and having a first vertical portion and second vertical portion and a U-shaped bottom portion, the roller chain being guided for reciprocating motion within the one or more masts, the roller chain having a plurality of pivotally connected links, each of the plurality of links being caused, when vertically aligned and pushed, to bear upon an adjacent link for forming a substantially rigid vertical lifting and lowering column portion having a column axis; and one or more sprockets mounted for rotation in the one or more masts, the one or more sprockets having a plurality of teeth formed thereon, the teeth having an involute profile for rollingly engaging the roller chain at the substantially rigid vertical column portion thereof; wherein the involute profile of the sprocket teeth engages the roller chain to translate substantially all of a rotational driving energy from the sprocket to the roller chain along a line of action perpendicular to a tangent to the involute curve, the line of action being along the column axis for movement of the roller chain along the column axis.

### BRIEF DESCRIPTION OF THE DRAWINGS

FIG. 1 is a perspective view of a roller chain and sprocket system according to an embodiment of the invention;

FIG. 2 is a side view of a sprocket according to an embodiment of the invention, illustrating an involute profile and a pitch diameter;

FIG. 3 is a color static nodal stress plot of the sprocket according to FIG. 2 illustrating a stress profile of the sprocket;

FIG. 4 is a schematic illustrating engagement of the involute teeth of a sprocket with a roller chain according to an embodiment of the invention;

FIG. 5 is a perspective view of a roller chain link according to an embodiment of the invention;

FIGS. 6A-6C illustrate a roller chain link according to an embodiment of the invention, more particularly

FIG. 6A is a perspective view of the roller chain link;

FIG. 6B is an side view according to FIG. 6A; and

FIG. 6C is a sectional view along lines A-A according to FIG. 6B;

FIGS. 7A-7D illustrate a roller chain link according to an embodiment of the invention, more particularly

FIG. 7A is a perspective view of the roller chain link;

FIG. 7B is a top view according to FIG. 7A;

FIG. 7C is a side view according to FIG. 7A; and

FIG. 7D is a front view according to FIG. 7A showing a pair of sprockets engaged therewith;

FIG. 8 illustrates a roller chain link according to an embodiment of the invention engaged with a sprocket according to an embodiment of the invention;

FIG. 9 is a perspective view of a plurality of sprockets according to FIG. 8 arranged on a shaft for engaging the rollers of a roller chain link according to FIG. 8;

FIG. 10 is a perspective view of an embodiment of a roller chain link;

FIG. 11 is a partial perspective view of a drilling rig utilizing a sprocket and roller chain system according to embodiments of the invention for raising and lowering a dolly in a drilling rig mast;

FIG. 12 is a front view of a sprocket and roller chain system for use in a drilling embodiment utilizing the roller chain links according to FIG. 6A-6C and a plurality of sprockets on each of a plurality of shafts driven in engagement with a roller chain, the mast omitted for clarity;

FIG. 13 is a perspective view according to FIG. 12;

FIG. 14 is a partial perspective view of a plurality of sprockets on a plurality of driven shafts according to FIG. 9, driven in engagement with a roller chain comprising roller chain links according to FIG. 6A-6C in use in a mast of a drilling rig;

FIG. 15 is a partial sectional view of the two sprockets ganged on a shaft, driven in engagement with a roller chain comprising roller chain links according to an embodiment of the invention for use in a mast of a drilling rig, a portion of the mast removed for clarity;

FIG. 16 is a side view a roller chain and sprocket arrangement for use in a drilling rig according to an embodiment of the invention and using roller chain links according to FIG. 5 and sprockets according to FIGS. 2-4, the sprockets being sized to engage a first and second linear portion of the roller chain;

FIG. 17 is a perspective view according to FIG. 16 illustrating a roller chain comprising 3-pin links and having follow bearings connected thereto for engaging a guide in the drilling rig;

FIG. 18 is a partial perspective view according to FIG. 11 a side of the mast being made transparent and a portion of the dolly removed to illustrate engagement of the sprockets with a linear portion of the chain;

FIG. 19 is a partial perspective view of an embodiment of the invention having two parallel spaced masts each having a roller chain system according to embodiments of the invention guided therein and a truss extending between the two masts and supported by the two roller chains for lifting and lowering a load therewith; and

FIG. 20 is a perspective view of a continuous roller chain comprising links according to FIG. 10 and being driven by a shaft having a plurality of sprockets thereon positioned at a linear section of the continuous roller chain.

### DETAILED DESCRIPTION OF THE PREFERRED EMBODIMENTS

Embodiments of the invention provide a system for pushing and pulling a load. While embodiments of the invention are described herein in the context of a drilling rig for lifting and lowering tubulars, those of skill in the art would appreciate that the system could be utilized to move a load in any direction. Embodiments of the system result in increased efficiencies and an ability to transmit maximum power for moving the load.

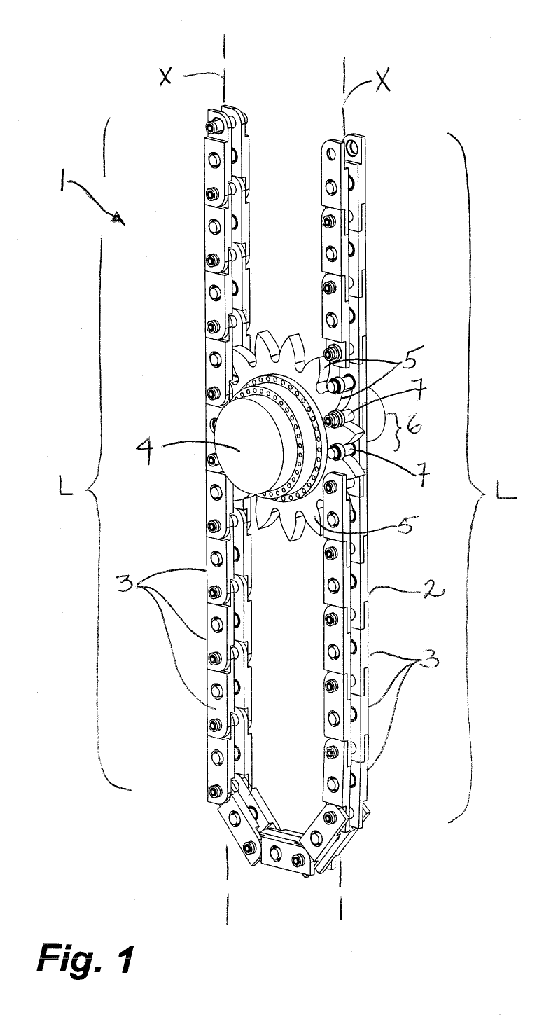

As shown in FIG. 1, the system 1 generally comprises an articulated roller chain 2 having a plurality of pivotally connected links 3 and one or more sprockets 4 which engage the roller chain 2 at a linearly arranged portion L thereof. When linearly aligned, the adjacent links 3 in the roller chain 2 are caused to bear upon one another end-to-end for forming a substantially rigid pushing column portion L of the roller chain 2 which is generally in compression. The roller chain 2 can also pull loads. The pushing and pulling column portion L has a column axis X. The one or more sprockets 4 have a plurality of teeth 5 formed thereon, each tooth 5 having an involute curve profile C. The profiled teeth 5 are received in voids 6 created between two or more rollers 7, in each of the links 3, for engaging at least one of the two or more rollers 7 for driving the roller chain 2.

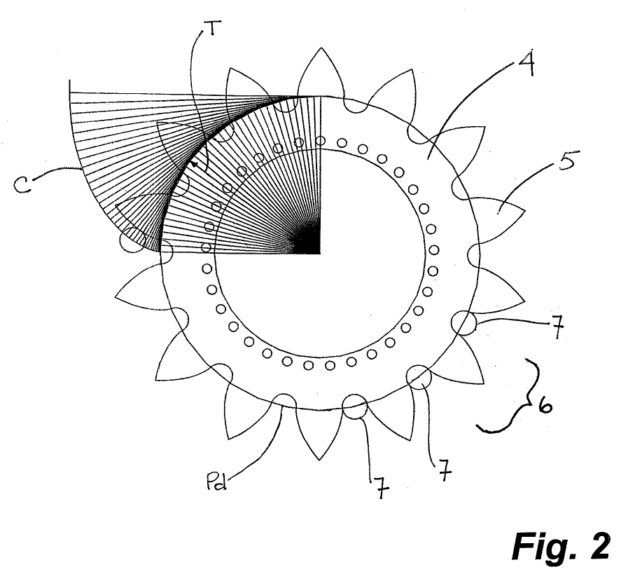

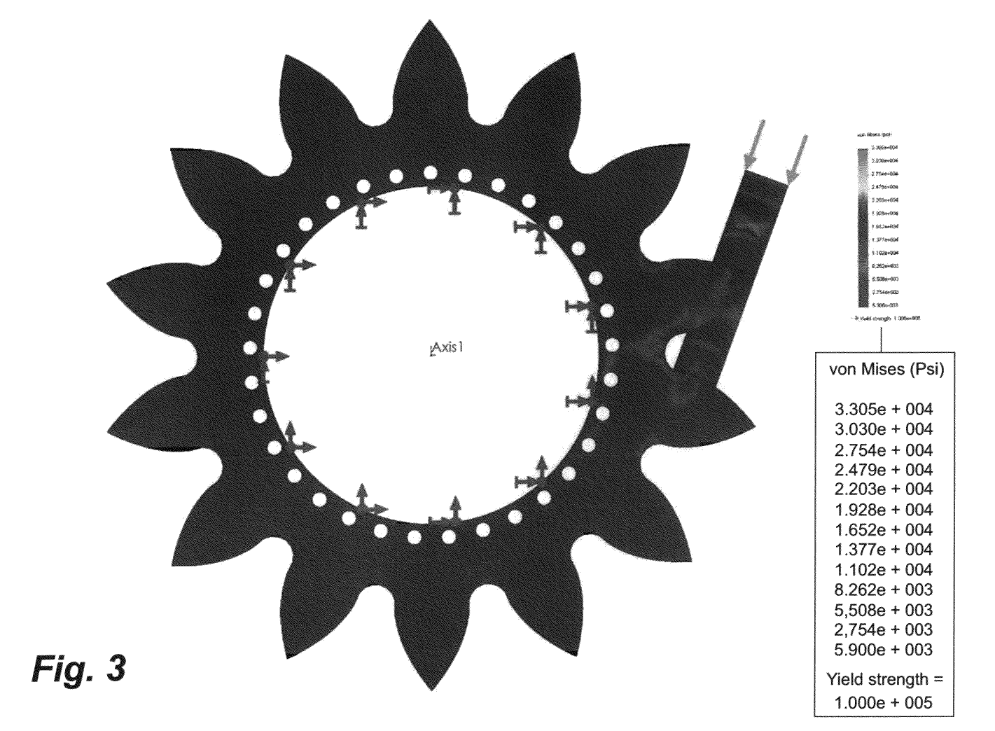

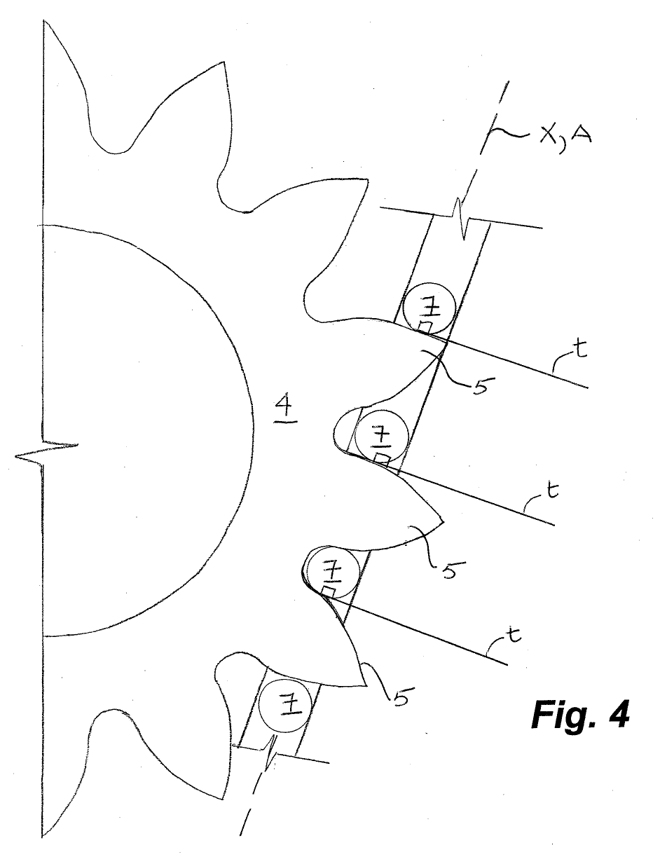

With reference to FIGS. 2-4 a pressure angle of substantially zero is created as a result of the involute curve profile C of the teeth 5. Substantially 100% of the rotational energy of the sprocket 4 is transmitted to the roller chain 2 along a line of action A perpendicular to a tangent t to the involute curve C, which is substantially the column axis X, for moving the roller chain 2 along the column axis X. Thus, there is little to no resulting negative action or thrust side loading and the roller chain 2 remains engaged with the sprocket 4 without the need for a prior art thrust backing plate or other such arrangement.

### Sprocket

As shown in FIGS. 2-4, and in embodiments of the invention, the sprocket teeth 5 have an involute profile which results in a driving force which is perpendicular to the torque developed by a driven shaft 8 of the sprocket 4 and therefore substantially 100% of the force generated is used for driving the chain 2. Further, as there is little to no radially outward or side loading on the chain 2, the sprocket 4 need only engage the chain 2 from one side, eliminating the need for a backing plate or an opposing driver design such as the opposing pinion gears used in prior art rack and pinion systems.

Prior art chain systems are arranged with chain at least partially wrapped about the sprocket, thus avoiding issues associated with radial forces. In embodiments of the present invention, the roller chain is not wrapped about the sprocket and instead, the sprocket engages the chain at a linear portion of the chain.

As is well known by those of skill in the art and as described in Machinery's Handbook 20^{th} ed. Industrial Press Inc. 1976 at page 740, the shape of the involute curve C is dependent only upon the size of the base circle. If a first involute, rotating at a uniform rate of motion acts against a second involute or against a straight line, the first involute will transmit a uniform angular motion to the second involute or straight line regardless the distance between the centers of the two base circles. The common tangent of the two base circles is both the path of contact and the line of action A.

In embodiments of the invention, the first involute is a tooth 5 on the sprocket 4 which acts against a straight line, being a pin or roller 7 of the roller chain 2. The straight line is tangent to the involute curve C and is substantially always perpendicular to its line of action A. When the roller chain 2 is constrained to move substantially in the direction of the line of action A, the roller chain 2 will be moved at a corresponding and uniform rate to that of the end of the generating line.

Having reference again to FIG. 2, the sprocket's pitch diameter circumference Pd is equal to the lineal displacement of the linear push chain per revolution and therefore the sprocket 4 meshes with the rollers 7 on the roller chain in a linear fashion. The load is perpendicular to the tooth 5 which is engaged and the torque arm T is ½ the pitch diameter Pd.

As one of skill in the art would appreciate, for large loads such as in a drilling rig, the tooth 5 to sprocket 4 diameter ratio must be adjusted to be suitable for the loads contemplated.

### Roller Chain

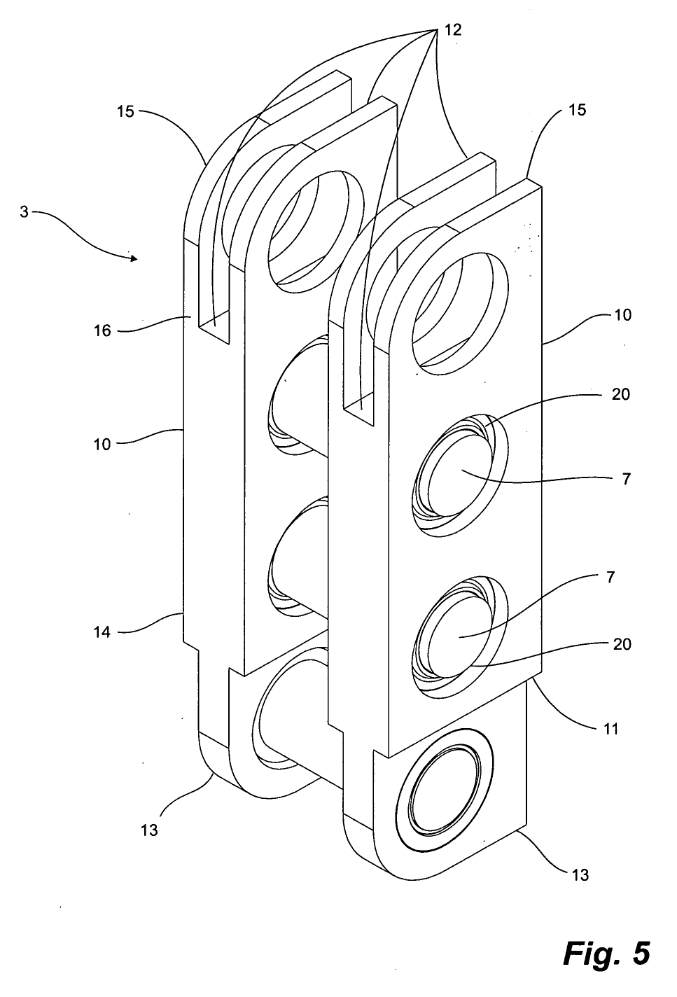

As shown in FIGS. 5, 6A-6C, 7A-7D, 8 and 10, the articulated roller chain 2 is formed by the plurality of pivotally interconnected links 3. Each linearly extending roller chain link 3 comprises a plurality of transversely extending pins or rollers 7 supported by one or more frame members 10. Each of the one or more frame members 10 comprises opposing end engagement faces 11,12 for engaging end engagement faces 11,12 on the one or more frame members 10 of an adjacent linearly aligned link 3. The engagement faces 11,12 of the linearly aligned adjacent links 3 bear upon one another during pushing for stacking and forming the substantially rigid linear column portion L. The engagement faces 11,12 form stacking surfaces which produce a resisting moment if a link is inclined to leave the linear arrangement.

Further, each frame member 10 comprises a tongue member 13 extending outwardly from a first end 14 and a groove member 15 extending outwardly from a second opposing end 16. The tongue member 13 of one link 3 is pivotally connected within the groove member 15 of the adjacent link 3 for permitting a pulling action and for articulation of the roller chain 2, particularly when the links 3 are not linearly aligned. In embodiments of the invention the adjacent links 3 are generally pivotally connected using a roller 7.

Applicant has contemplated embodiments having three or four or more rollers 7 in each link 3.

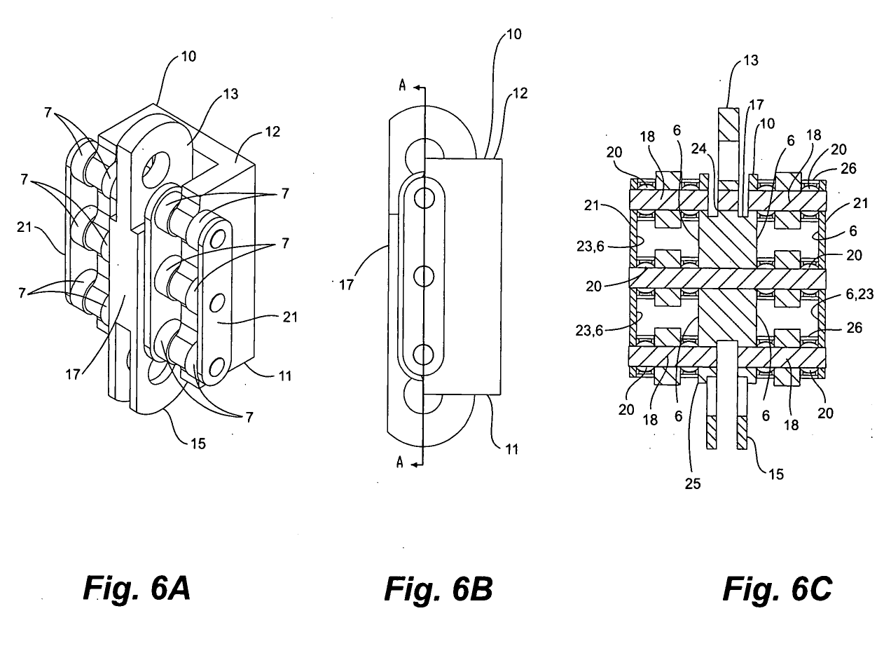

In embodiments of the invention and best seen in FIG. 6C, each of the rollers 7 is supported for rotation by bearings 20, such as radial spherical bearings 20 for rolling engagement with the teeth 5 of the one or more driven sprockets 4, such as shown in FIG. 2. Use of bearings 20 for rotationally supporting the rollers 7 permits the rollers 7 to roll on the surface of the involute curve C of the teeth 5 of the sprocket 4, thereby reducing any friction therebetween. Typically the bearings 20 are maintenance-free, spherical, sealed bearings 20 (GE 35-FW-2RS—available from Schaeffler Canada Inc., Delta, B.C., Canada).

### EXAMPLES

### Roller Chain Links

As shown in FIGS. 5, 6A-6C and 10, the plurality of rollers 7 and the one or more frame members 10 may be arranged to engage the teeth 5 on one sprocket 4 or on more than one sprocket 4.

As shown in FIG. 5, the links 3 comprise two, spaced-apart frame members 10,10 and a plurality of transversely extending rollers 7 connecting therebetween. The rollers 7 in each link 3 are spaced along the frame members 10,10 to form a linear series of voids 6 for receiving teeth 5 of a single driven sprocket 4. Each of the frame members 10,10 has a groove member 15 and a tongue member 13 which extending linearly outwardly at opposing ends 14,16 of the frame members 10,10.

In the embodiment shown, three pins or rollers 7 are used to create two voids 6 into which the sprocket teeth 5 are received for engagement with the rollers 7.

Further, in embodiments of the invention, the rollers 7 are supported on bearings 20 fit to the frame member 10 in such a manner that the sprocket teeth 5 engage the rollers 7 between the bearings 20. In this embodiment, the rollers 7 are subject to shear loading.

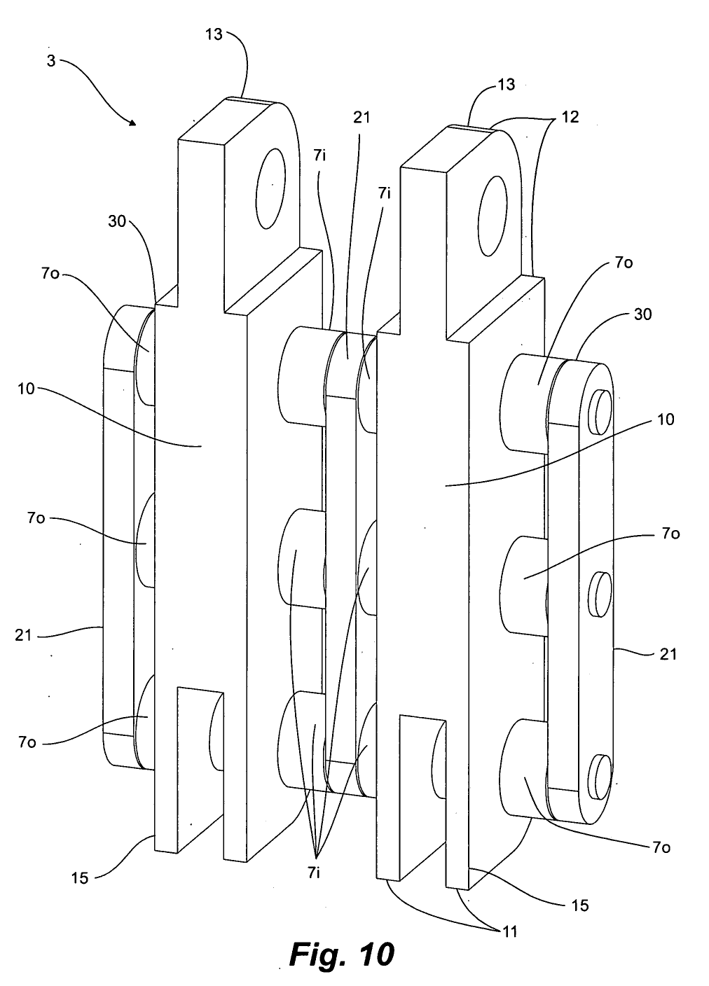

As shown in FIGS. 6A-6C and 10, the one or more frame members 10 and the plurality of rollers 7 are arranged so as to create more than one parallel, linearly extending series of voids 6 so as to engage a plurality of parallel or ganged sprockets 4 mounted on a single driven shaft 8.

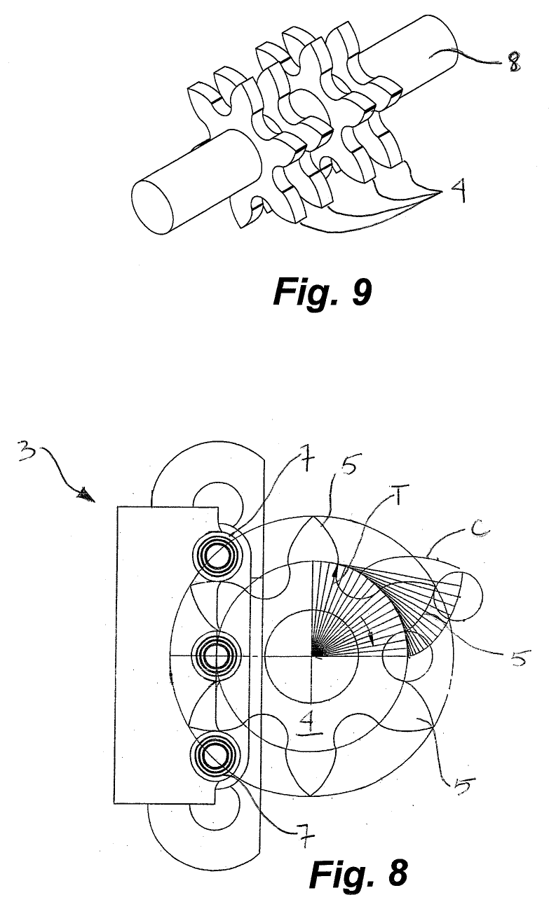

As shown in FIGS. 6A-6C, an embodiment of the roller chain link 3 comprises an “E”-shaped frame member 10. A plurality of rollers 7, supported for rotation by roller bearings 20, extend perpendicularly outward from a central member 17 of the frame member 10 and are supported at about a center 18 of the rollers 7 by outer members of the “E”-shaped frame 10. End plates 21 support distal ends of the rollers 7 and enclose spaces 23 therebetween for forming voids 6 through which the sprocket teeth 5 are received and engage the rollers 7. The central member 17 supports a tongue member 13 and a groove member 15 at opposing ends 24,25 of the central member 17 to permit articulated connection between adjacent link members 3. In one embodiment, each roller chain link 3 is therefore capable of engaging four sprockets 4 suitably spaced axially along a driven shaft 8. In one embodiment, three parallel and spaced sets of rollers 7 are used on each side of the central member 17 for forming two voids 6, thus the link 3 is capable of engaging two adjacent teeth 5 between rollers 7 on each sprocket 4 at the same time. (See FIGS. 8 and 9). The rollers 7 are supported by radial spherical bearings 20 in a roller sleeve 26.

Applicant is aware that in this embodiment, the ganged parallel sprockets 4 on a single driven shaft 8 may be subject to a measure of winding up which may result in some lack of synchronicity of engagement with the roller chain 2 between the ganged sprockets 4 mounted thereon.

In this embodiment, the rollers 7 are supported in the frame member 10 and a bearing 20 is supported on the roller 7 between the portions of the frame member 10. In this embodiment, the sprockets 4 engage the bearings 20 and the rollers 7 are subject to both shear loading and bending loading.

Having reference to FIG. 10 and in an embodiment of the invention, the roller chain link 3 comprises two frame members 10,10 spaced apart by a plurality of rollers 7. Each frame member 10,10 has three inner rollers 7i and three outer rollers 7o spaced linearly along the frame members 10,10 for forming linear sets of voids 6 therebetween. An endplate 21 is positioned between the inner rollers 7i of the two frame members 10,10. Further an endplate 21 is positioned at each outward end 30 of the outer rollers 7o. The inner and outer rollers 7i,7o are supported for rotation on a shaft 8 extending through the frame members 10 and the endplates 21.

As in the embodiment described for FIG. 5, each of the frame members 10 has a groove member 15 and a tongue member 13 which extending linearly outwardly at opposing ends 14,16 of the frame member 10.

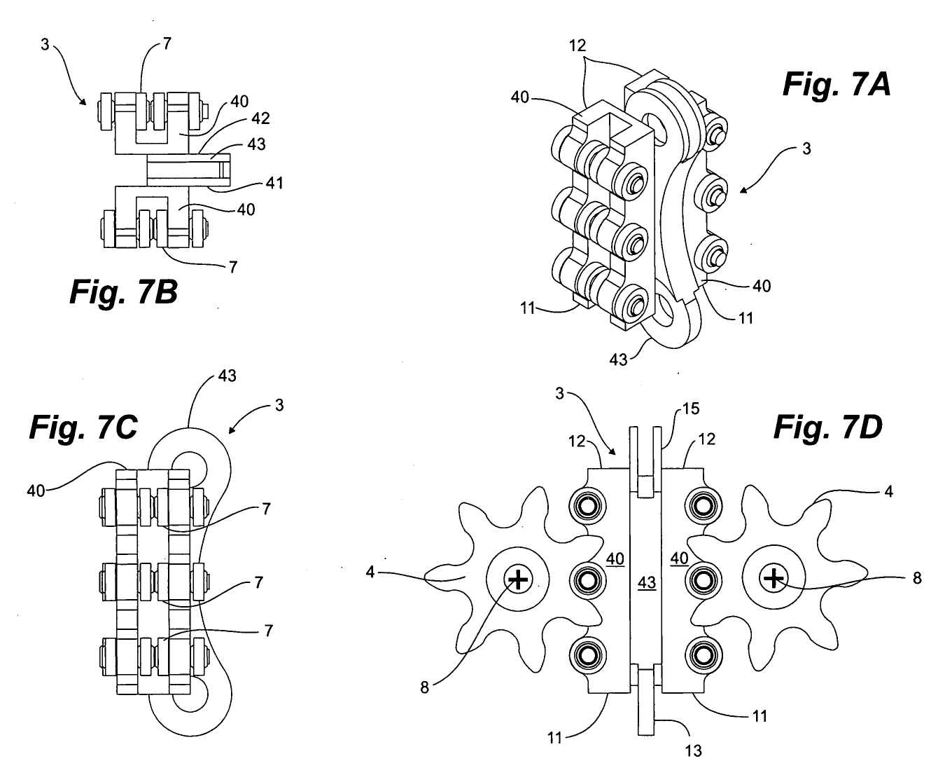

As shown in FIGS. 7A-7D, and in an embodiment of the invention wherein the roller chain 2 is sandwiched between opposing sprockets 4, the roller chain link 3 comprises two C-shaped frame members 40,40, each of the C-shaped frame members 40,40 supporting a plurality rollers 7 thereon. The C-shaped members 40,40 are supported on opposing sides 41,42 of a central link member 43, an axes of the rollers 7 being oriented substantially parallel to the central member 43. The central link member 43 may be arcuate in shape or have one edge which is arcuate in shape. The C-shaped members 40,40 are mounted to the central member 43 so as to offset the rollers 7 relative to the central link member 43. The drive sprockets 4 are oriented 90° to the embodiments of FIGS. 6A-6C.

### Roller Chain and Sprocket System

As one of skill in the art would appreciate, in designing a roller chain and sprocket system, the diameter of the rollers (P1), under specific load, must have a conservative safety factor which is determined as a function of the roller material and the diameter of the roller.

In an embodiment of the invention, the minimum spacing between rollers in the link is 2×P1 to provide stability to the system. The tooth root thickness on the sprocket teeth is made equal to the diameter of the rollers. For example in a 12-tooth sprocket for engaging a chain having a 2×P1 spacing, the pitch circumference is 24×P1 and two teeth engage two rollers in the link at any given time during operation. In a 21-tooth sprocket having a pitch circumference of 42×P1, three teeth engage three rollers at any given time during operation. Thus, it is apparent that the more teeth there are on the sprocket, the more teeth will engage the roller chain at any given time.

To increase the safety factor of the sprocket, the roller spacing may be increased, for example to 2.9×P1 to accommodate an increase in the tooth root thickness. Thus, in a 15-tooth sprocket the circumference is 43×P1 but the safety factor is doubled compared to using the 2×P1 spacing example.

In embodiments of the sprocket and roller chain system, surface hardening and lubrication are typically not required as there is little to no friction between the driving surfaces.

Softer, low temperature-capable materials, unaffected by ductile brittle transition temperature and suitable for use in cold climates, are suitable sprocket materials according to embodiments of the invention. In a stress analysis, loading the sprocket to 175,000 lbs resulted in a stress of 25,000 psi which was lower than the stress (35,700 psi) on the gear wheel of a conventional rack and pinion system under significantly lower loading (41,667 lbs).

### Drilling Rig

Embodiments of the invention are particularly suited for vertical translation of heavy loads, such as tubulars, within one or more masts 100 on a platform 101 of a drilling rig 102.

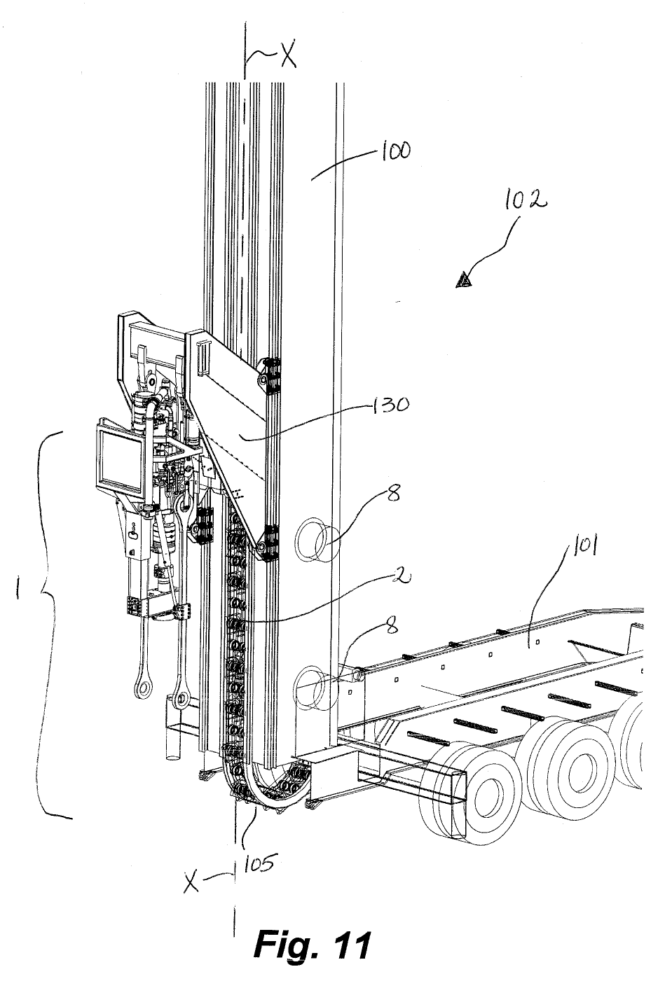

Best seen in FIGS. 11, 15, 18 and 19, and in embodiments of the invention, the roller chain 2 is supported for reciprocating action in a mast 100 of the drilling rig 102 so as to lift and lower the load. The roller chain 2 is guided in a U-shape having a first linear vertical portion 103, a second linear, vertical portion 104 and a U-shaped bottom portion 105. One or more single sprockets 4 or a plurality of ganged sprockets 4 are mounted on one or more driven shafts 8 supported in the mast 10 so as to permit the one or more sprockets 4 to engage the roller chain 2 at at least one of the first or second linear vertical portions 103,104 thereof. The one or more sprockets 4 are spaced above the U-shaped bottom portion 105 so as to ensure the roller chain 2 is meshed with the one or more sprockets 4 at the linear portion L of the roller chain 2. The transmission of substantially 100% of the circular power from the one or more driven sprockets 4 results in vertical motion of the roller chain 2 along the column axis X, substantially without side loading as previously described.

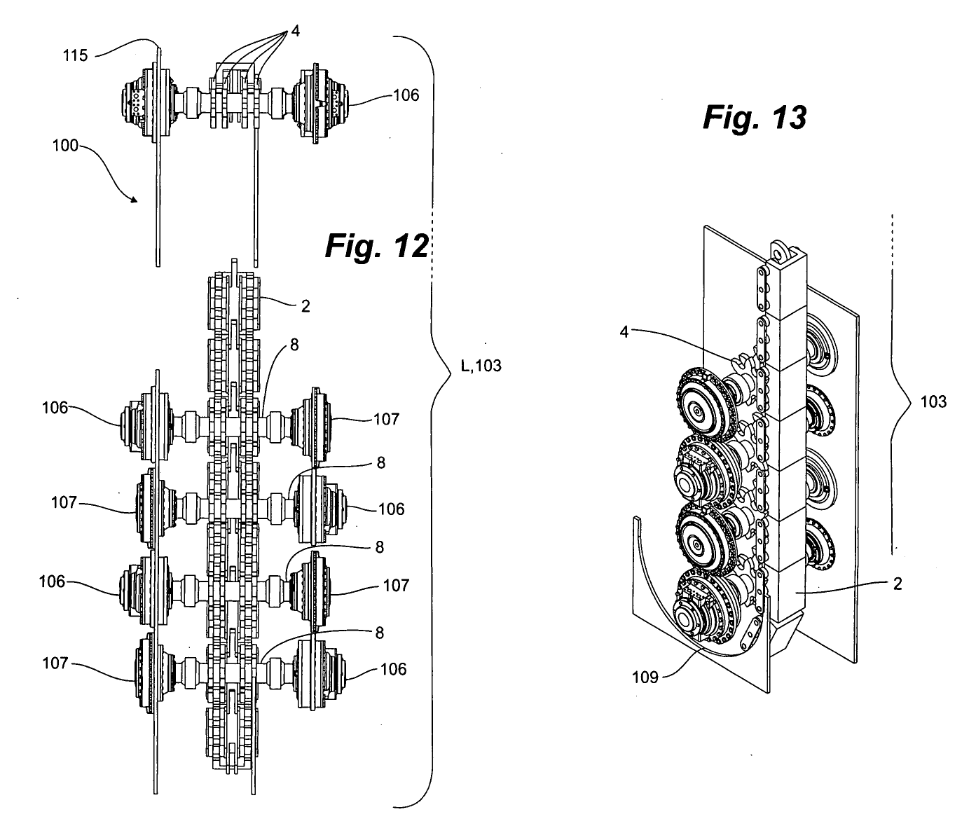

Further, with reference to FIGS. 12, 14, and 17 and in embodiments suitable for use in a drilling or service rig 102, the one or more driven shafts 8 are driveably connected to one or more conventional motors 106, such as a hydraulic motor. Dynamic/static braking 107 can be provided on each of the driven shafts 8 to slow and to stop the load. Typically, emergency braking is also provided to lock the shafts 8 against rotation when stopped.

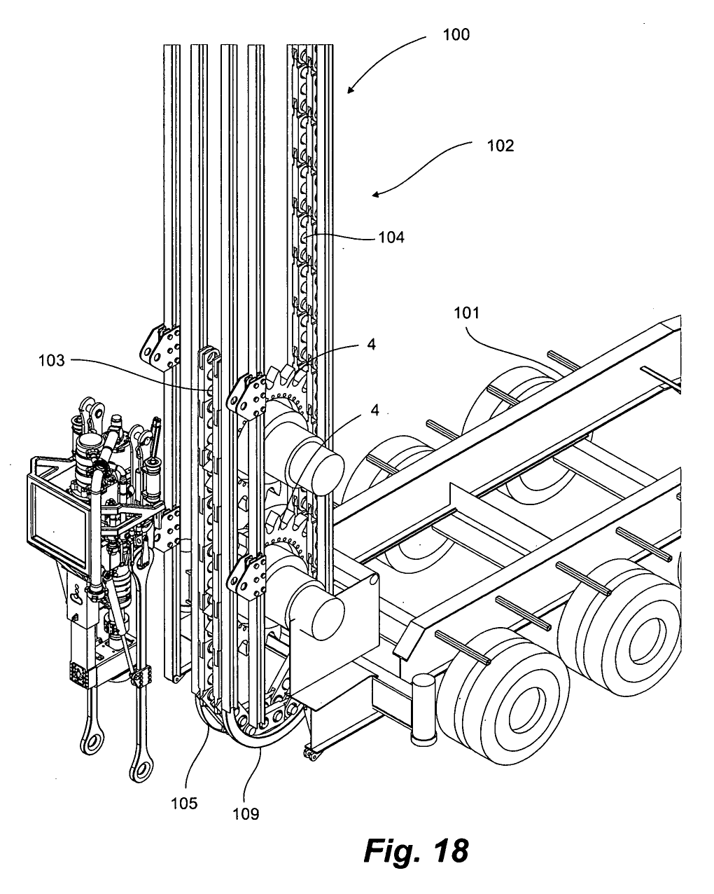

Typically, having reference to FIGS. 13 and 18, guide sections 109 are positioned at the U-shaped bottom 105 for supporting the chain 2 through the curve-shaped bottom portion 105. Optionally, follow bearings 110 may extend radially outward from opposing sides of the chain links 3 to co-operate with the mast 100 and with the guide sections 109 for guiding the roller chain 2 therealong. The follow bearing 110 can extend from the rollers 7.

Additionally, guide plates (not shown) may be positioned to oppose the one or more sprockets 4 as a backup to further ensure the roller chain 2 does not disengage from the sprockets 4.

As shown in FIGS. 12 and 13, an embodiment utilizing a U-shaped roller chain 2 comprises interconnected links 3 according to FIGS. 6A-6C and is supported in the drilling mast 100. Four driven shafts 8, each having four spaced, ganged sprockets 4 supported for rotation thereon, are positioned in vertical alignment above the bottom 105 of the U-shaped chain 2 and along the linear vertical portions 103 of the roller chain 2 for engaging the roller chain 2 at the first linear portion 103 thereof.

Optionally as shown in FIG. 12, at least one additional driven shaft 8 having four spaced ganged sprockets 4 supported thereon may be positioned adjacent a top end 115 of the first linear portion 103 of the roller chain 2 for aiding in lifting the chain 2 in a drilling mast 100.

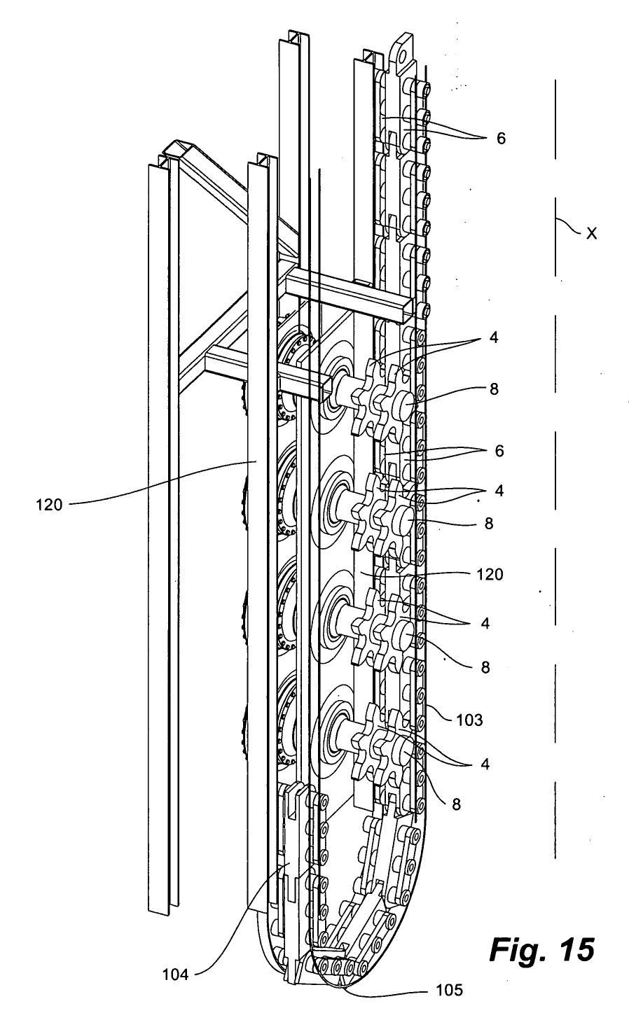

A plurality of sprockets 4 can be splined onto a driven shaft 8 for engagement with the rollers 7 on the roller chain links 3. FIG. 15 illustrates an embodiment of the invention utilizing two sprockets 4 on each of four driven shafts 8 and a co-operating link 3 design having two parallel series of vertical voids 6 formed therein for engaging the two ganged sprockets 4 on each driven shaft 8.

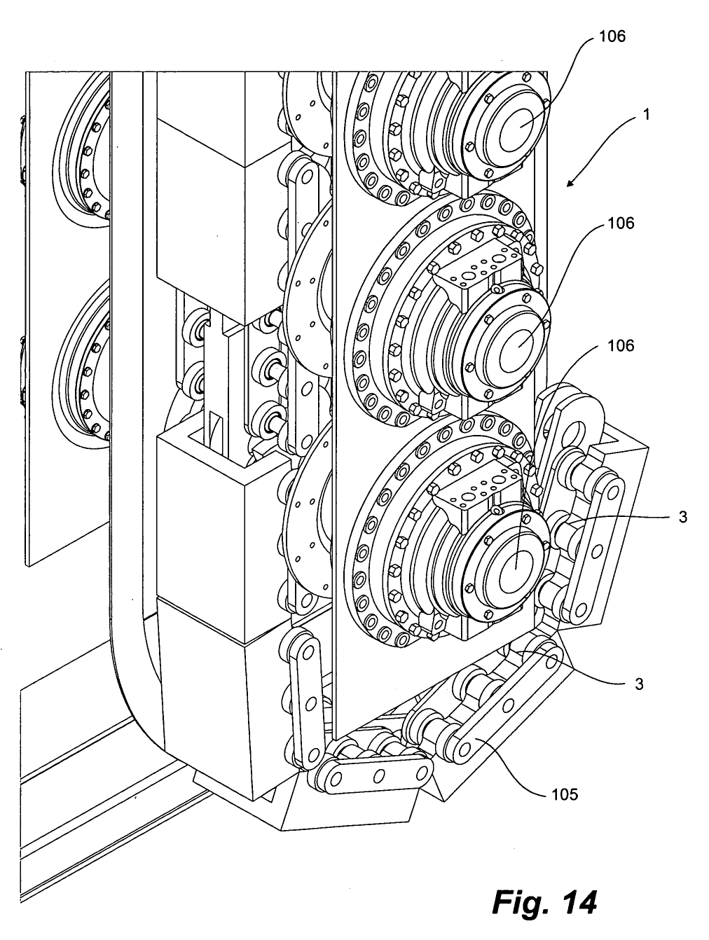

As shown in FIGS. 14 and 15, the roller chain links 3 of FIGS. 6A-6C are interconnected to form a U-shaped chain 2 guided in the mast 100 of a drilling rig 102. With reference to FIG. 9, four ganged sprockets 4 can be supported on each driven shaft 8.

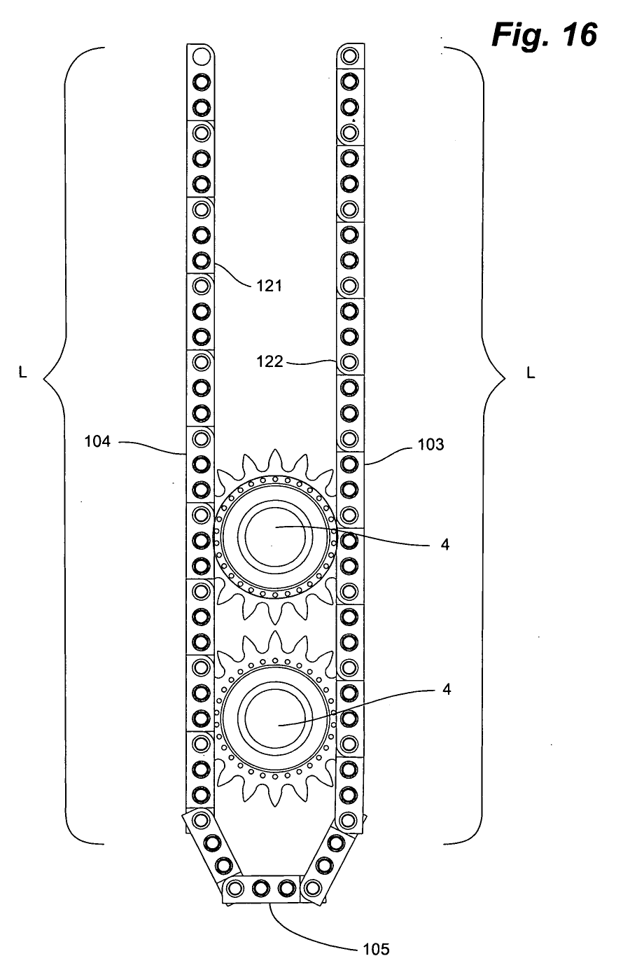

As shown in FIG. 16, at least a portion of the rollers 7 further comprise follow bearings 110 on opposing sides 11,112 of the roller chain 2 to engage the guide sections 109 adjacent the bottom of the mast 100 for supporting the bottom 105 of the chain 2 for movement therealong.

Typically, as shown in FIG. 15, stabilizing tracks 120 can be employed in the mast 100 to assist in maintaining the links 3 in the linearly aligned column portion L and for strengthening the column L when aligned vertically.

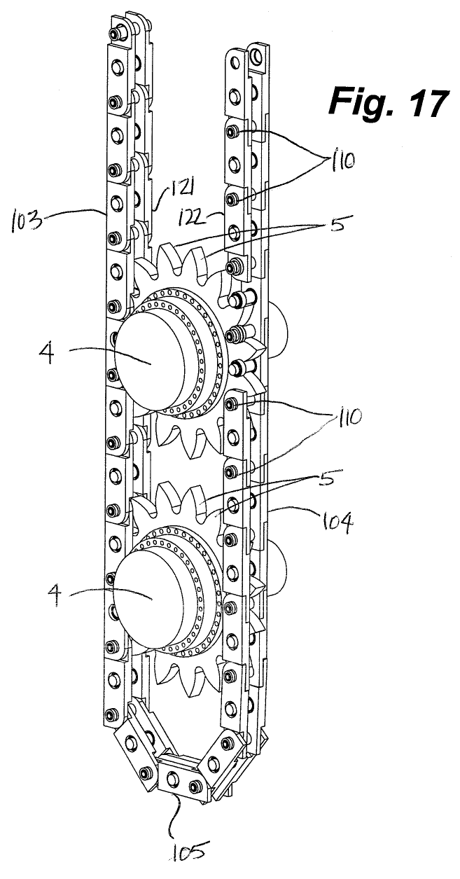

As shown in FIGS. 16 and 17, and in an embodiment of the invention using the roller chain link 3 embodiment shown in FIG. 5, one or more sprockets 4 are positioned in a vertical array within the mast 100 of the drilling rig 102. The sprockets 4 are positioned along a linear portion L, 103,104 of the roller chain 2 above the U-shaped bottom 105. Conveniently in this embodiment, due to the size of the sprocket 4 required to drive the chain 2, the sprocket 4 is able to engage the roller chain 2 at opposing sides 121,122 and therefore acts to simultaneously push and pull the roller chain 2 within the mast 100 such as shown in FIGS. 11 and 18.

Having reference to FIG. 11, a dolly 130 is operatively connected to embodiments of the sprocket and roller chain system 1 for housing apparatus required for manipulating the load.

In an embodiment of the invention, best seen in FIG. 17, follow bearings 110 extend outwardly from at least one of the rollers 7 on each of the links 3 along a length of the roller chain 2 for engaging a guide section or support track 109 for aiding in guiding and stabilizing the chain 2 therealong. The U-shaped support track 109 is provided at the bottom of vertical tracks for supporting the U-shaped bottom portion 105 of the chain 2 therealong. In this embodiment, motors 106 used to drive the shafts 8 for rotation of the sprockets 4 may be hydraulic winch motors. In one embodiment contemplated, Applicant believes that each of two sprockets 4 is capable of lifting 175,000 pound (175K) making the rig substantially a 350,000 pound (350K) rig.

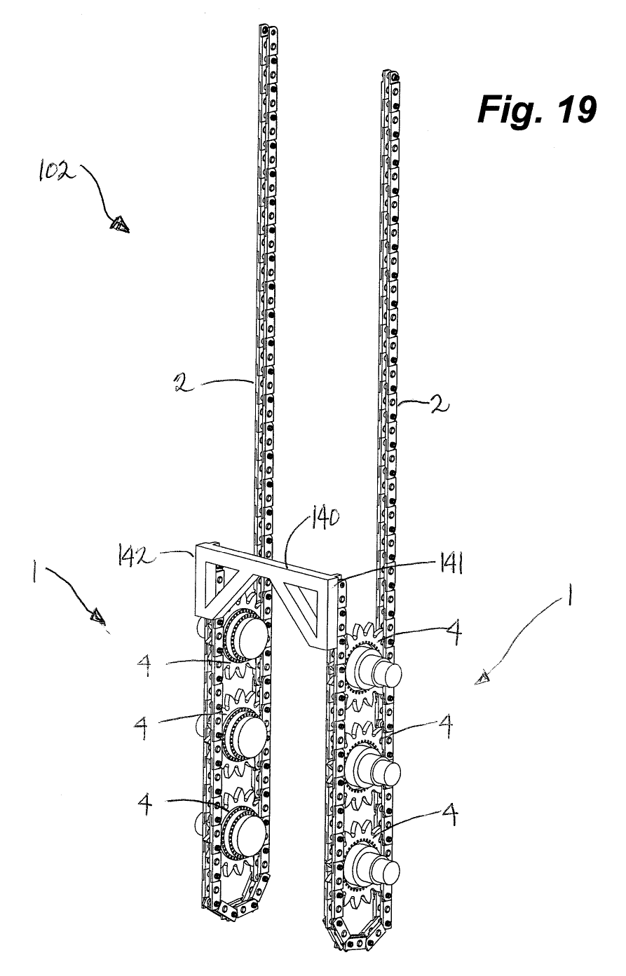

In an embodiment of the invention shown in FIG. 19, two parallel masts (not shown) are spaced apart for supporting on a drilling rig platform. Each of the masts supports a U-shaped roller chain 2 and one or more sprockets 4 as described in embodiments of the invention. A truss 140 extends between the two masts and is operatively connected at opposing ends 141,142 to the two U-shaped roller chains 2 for supporting a load therebetween. The load is operatively connected to the truss 140 for lifting and lowering as the two U-shaped chains 2,2 are synchronously reciprocated in each of the two masts. Utilizing the dual sprocket and roller chain systems 1,1, the drilling rig 102 of this embodiment is capable of lifting loads of about 1,050,000 pounds (1050K).

### Continuous Roller Chain

In an embodiment of the invention, the roller chain 2 may be formed into a continuous chain 2. The roller chain 2 may be formed using links 3 according to FIG. 10 or links 3 according to other embodiments of the invention.

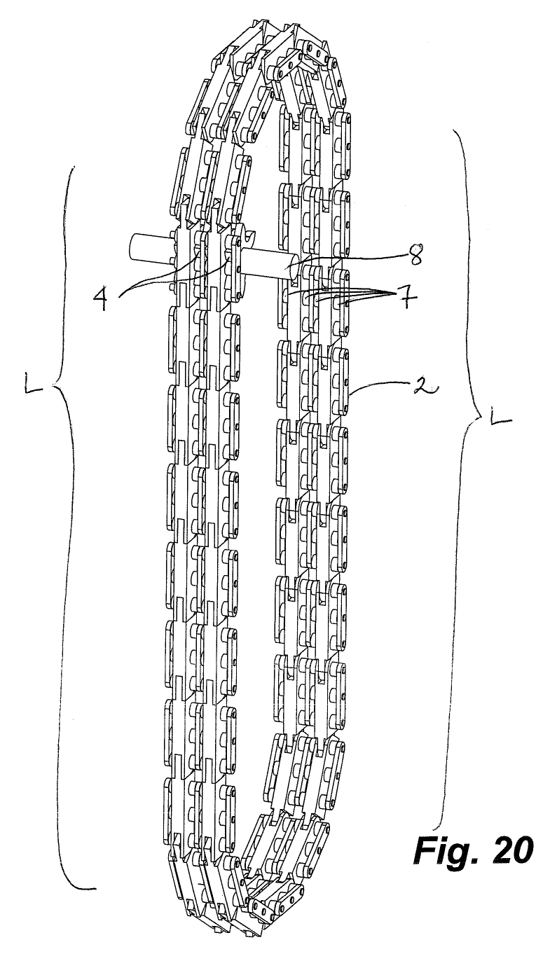

As shown in FIG. 20, one or more sprockets 4 are positioned on a driven shaft 8 so as to engage the rollers 7 of the roller chain 2 at a linear portion L thereof for driving the chain 2 in a direction which is perpendicular to the torque developed by the driving shaft 8 of the sprocket 4. The continuous roller chain 2 and sprocket 4 arrangement may be used in a variety of industries where a continuous chain is desirable.

The embodiments of the invention in which an exclusive property or privilege are claimed are defined as follows:

1. A system for pushing a load comprising:
an articulated roller chain having a plurality of pivotally connected links, each of the plurality of links being caused, when linearly aligned and pushed, to bear upon an adjacent link for forming a substantially rigid linear column portion having a column axis; and
one or more sprockets having a plurality of teeth formed thereon, the teeth having an involute profile for engaging the roller chain at the substantially rigid linear column portion thereof,
wherein the involute profile of the sprocket teeth engages the roller chain to translate substantially all of a rotational driving energy from the sprocket to the roller chain along a line of action perpendicular to a tangent to the involute curve, the line of action being along the column axis for movement of the roller chain along the column axis.

2. The system of claim 1 wherein a pressure angle is substantially zero degrees.

3. The system of claim 1 wherein each of the plurality of links further comprises:
one or more frame members, the frame members bearing upon the frame members of the adjacent link for forming the substantially rigid linear column; and
two or more spaced rollers extending transversely between the two or more frame members for forming at least one void for receiving one of the one or more teeth of the one or more sprockets.

4. The system of claim 3 wherein the one or more frame members further comprise:
a first engagement face formed at a first end of each of the one or more frame members; and
a second engagement face formed at a second end of the one or more frame members,
wherein when the plurality of links are linearly aligned, the second engagement face of the plurality of links bears upon the first engagement face of an adjacent link of the plurality of links.

5. The system of claim 4 wherein the one or more frame members further comprise:
a tongue member extending outwardly from the first end beyond the first engagement surface; and
a groove member extending outwardly from the second end beyond the second engagement surface
wherein the tongue member of one of the plurality of links is pivotally connected to the groove member of the adjacent link.

6. The system of claim 3 wherein each of the plurality of links further comprises:
three spaced rollers for forming two voids therebetween for receiving two or more teeth of the one or more sprockets.

7. The system of claim 3 wherein each of the plurality of links further comprises:
four spaced rollers for forming three voids therebetween for receiving two or more teeth of the one or more sprockets.

8. The system of claim 3 wherein the rollers are supported by bearings; and
wherein the sprocket teeth engage the one or more rollers between the bearings.

9. The system of claim 3 wherein the rollers are bearings and wherein the sprocket engages the bearings.

10. The system of claim 1 wherein the roller chain is guided in a U-shape having a first linear portion and a second linear portion connected therebetween by a U-shaped connecting portion; and
wherein the one or more sprockets are positioned between the first and second linear portions and spaced away from the U-shaped connecting portion, each of the two or more sprockets engaging either of the first linear portion or the second linear position, or both, for alternately pushing or pulling the roller chain along the column axis.

11. The system of claim 10 wherein the one or more sprockets are are sized so as to engage both the first and second linear portions for simultaneously pushing and pulling the roller chain along the column axis.

12. The system of claim 1 wherein the roller chain is a continuous chain; and
wherein the one or more sprockets engage the continuous chain at a linear portion thereof.

13. The system of claim 1 wherein the column axis is a substantially vertical axis for lifting and lowering the load.

14. The system of claim 1 further comprising:
two or more sprockets ganged on a single shaft; and
wherein the links comprise two or more parallel, linearly extending series of voids for receiving one or more teeth of each of the two or more ganged sprockets therein.

15. The system of claim 1 wherein the one or more sprockets are each supported for rotation on a separate shaft.

16. A rig for raising and lowering a load comprising:
a platform;
one or more masts supported on the platform;
a U-shaped articulated roller chain for raising and lowering the load and having a first vertical portion and second vertical portion and a U-shaped bottom portion, the roller chain being guided for reciprocating motion within the one or more masts, the roller chain having a plurality of pivotally connected links, each of the plurality of links being caused, when vertically aligned and pushed, to bear upon an adjacent link for forming a substantially rigid vertical lifting and lowering column portion having a column axis; and
one or more sprockets mounted for rotation in the one or more masts, the one or more sprockets having a plurality of teeth formed thereon, the teeth having an involute profile for rollingly engaging the roller chain at the substantially rigid vertical column portion thereof;
wherein the involute profile of the sprocket teeth engages the roller chain to translate substantially all of a rotational driving energy from the sprocket to the roller chain along a line of action perpendicular to a tangent to the involute curve, the line of action being along the column axis for movement of the roller chain along the column axis.

17. The rig of claim 16 wherein each of the one or more sprockets are mounted on one or more shafts and further comprising:
one or more motors supported in the one or more masts for rotationally driving the one or more shafts.

18. The rig of claim 16 further comprising:
a dolly operatively connected between the mast and the substantially rigid linear column portion for engaging the load.

19. The rig of claim 16 further comprising:
two parallel masts, spaced apart and supported on the platform;
two U-shaped articulated roller chains, each of the two roller chains being supported in one of the two masts; and
a truss extending between and operatively connected to the two roller chains for supporting the load therebetween.

20. The rig of claim 16 further comprising static and dynamic braking operatively connected to the one or more shafts for slowing and arresting movement of the roller chain.

21. The rig of claim 20 wherein the braking further comprises emergency braking for locking the one or more shafts against rotation when arrested.
